(19) United States
(12) Patent Application Publication
(10) Pub. No.: US 2014/0321931 A1
(43) Pub. Date: Oct. 30, 2014

(54) HYBRID CUTTING TOOL, CHIP TRANSPORTING PORTION AND PROCESS FOR PRODUCING A CUTTING TOOL

(71) Applicant: Kennametal Inc., Latrobe, PA (US)

(72) Inventor: CHRISTOPH GEY, ZIRNDORF (DE)

(73) Assignee: KENNAMETAL INC., Latrobe, PA (US)

(21) Appl. No.: 14/260,551

(22) Filed: Apr. 24, 2014

(30) Foreign Application Priority Data
Apr. 25, 2013 (DE) 102013104222.8

(51) Int. Cl. B23B 51/02; B23B 51/06

(52) U.S. Cl. CPC B23B 51/02; B23B 51/06; B23B 2251/40; B23B 2240/00; B23B 2228/36
USPC 408/57; 408/199; 76/108.6

(57) ABSTRACT

Provision is made of a cutting tool, in particular a drill or a milling cutter, having a shank and a chip transporting portion, which receives a cutting insert, wherein the cutting tool is a hybrid composite body. Furthermore, a chip transporting portion for a cutting tool and also a process for producing a cutting tool are described.

### BACKGROUND

1. Field of the Invention

Embodiments of the present invention relate to a cutting tools, chip transporting portions and to processes for producing cutting tools.

2. Background Information

Cutting tools such as drills, milling cutters, turning and piercing tools or reaming tools are known from the prior art. Typically, a cutting tool of this type has a shank, by way of which the cutting tool can be chucked into a machine tool, and also a working portion, which, in the case of a drill, is designed to receive a cutting insert. A cutting tool of this type is usually produced in a milling process, in which case various portions, for example a chip transporting portion of the cutting tool in the case of a drill, can additionally be ground. In an alternative process for producing a cutting tool, it is provided that the cutting tool is produced by means of a sintering process, this process being distinguished by virtue of the fact that it is possible to use materials which could not be combined with one another in conventional processes. The chip transporting portions in particular have an increasingly complex structure, and therefore they have to undergo post-machining in complex processes. This concerns in particular the coolant ducts, which are provided in the chip transporting portions and either have to be subsequently introduced with large expenditure or are drilled into the blank of the chip transporting portion, which is then heated and twisted in order to produce helical flutes.

It has been found to be disadvantageous that the production of the cutting tools known to date is both complicated and costly.

### SUMMARY OF THE INVENTION

Starting therefrom, a basis for the present invention is to provide a cutting tool which can be produced flexibly and with relatively complex structures in a simple and cost-effective process.

Such basis is achieved according to the invention by a cutting tool, in particular a drill, a milling cutter, a turning and piercing tool or a reaming tool, having a shank and a working portion, which receives a cutting insert, wherein the cutting tool is a hybrid composite body. A hybrid composite body is to be understood as meaning that two differently produced partial regions are fixedly connected to one another. A hybrid cutting tool of this type thus has a shank and a working portion, in particular a chip transporting portion, which have been produced in different processes. It is thereby possible that the cutting tool on the one hand can be matched to the corresponding requirements and on the other hand can be produced efficiently and with reduced costs. For the shank, which usually does not have a complex geometry, it is possible to use a conventional raw material, which can be turned in view of the tolerances to be observed. By contrast, the chip transporting portion, which typically represents the more complex structure, is preferably produced by a process from the group of the rapid prototyping processes. This process makes it possible to produce structures which are very complex, in which case the thus produced structures do not have to be subsequently machined. It can be provided that the chip transporting portion is partially or else completely subsequently ground only if certain requirements in terms of surface quality and fit have to be observed. The cutting tool according to the invention therefore has the effect that merely the more complex part of the tool, specifically the chip transporting portion or part of the chip transporting portion, is produced by a process from the group of the rapid prototyping processes, whereas the regions of the tool having a simpler geometry, specifically the shank, are produced conventionally. This ensures that those parts of the tool which can be provided by a relatively inexpensive process do not also have to be produced by the more complex rapid prototyping process.

It is preferably provided that the chip transporting portion is fixedly connected, in particular soldered, welded or screwed, to the shank. This means that the shank and the chip transporting portion can be produced completely separately, with the chip transporting portion then being fixedly connected to the shank in order to establish a force-fitting connection. This moreover makes it possible to build up a type of modular concept, in which case shanks can be combined with an extremely wide variety of chip transporting portions.

In a preferred embodiment, it is provided that the chip transporting portion is grown directly onto the shank. To this end, firstly the shank is produced, with the chip transporting portion being grown directly onto the shank which is already present by means of a process from the group of the rapid prototyping processes. A separate point of connection between the shank and the chip transporting portion, such as a welded joint or the like, is therefore not necessary. Therefore, it is possible to produce a cutting tool with a complex chip transporting portion structure in few process steps.

In particular, it is provided that the material for the chip transporting portion is virtually free of pores, in particular is free of pores to an extent of more than 98% and particularly preferably to an extent of more than 99.9%. A pore-free material of this type is a particularly suitable material, since it has an increased stability. The shank can similarly be produced from the same material as the chip transporting portion.

In a particularly preferred embodiment, it is provided that the chip transporting portion has an internal coolant duct. The coolant duct is used to cool a cutting insert which has been inserted with a liquid. The coolant duct runs within the chip transporting portion, in particular like a helix, as a result of which the internal structure of the chip transporting portion is correspondingly complex. Nevertheless, it is possible to easily produce a chip transporting portion of this type using a process from the group of the rapid prototyping processes.

The coolant duct preferably has a changing cross section. Unlike in conventional tools, a changing cross section can be produced with little expenditure. With a changing cross section, it is possible to split the volumetric flow of the coolant in a desired manner between a plurality of different coolant ducts. It is also possible to configure the outlet opening of the coolant in such a way that it acts in the manner of a nozzle.

In general terms, the chip transporting portion of the cutting tool can have complex structures, since complex structures can be produced in a simple manner by means of the rapid prototyping process. Post-machining, for example grinding, is only required if particularly high demands on the surface quality or tolerances have to be observed.

Furthermore, provision is made of a chip transporting portion for a cutting tool, which has a coupling region, which bears a cutting edge, and also a connection region for connecting the chip transporting portion to a shank, wherein at least the coupling region has been produced by a process from the group of the rapid prototyping processes. A chip transporting portion of this type is distinguished by the fact that merely the complex part of the chip transporting portion, specifically the coupling region, is produced by means of a process from the group of the rapid prototyping processes. The chip transporting portion can then be connected, in particular welded, soldered or screwed, to a shank.

By way of example, the connection region can be prefabricated, such that merely the coupling region is grown onto the connection region. In this case, the connection region can preferably consist of a sintered material, or can be sintered.

It can also be provided that the entire chip transporting portion, i.e. the coupling region and the connection region, has been produced by a process from the group of the rapid prototyping processes.

It is preferably provided that the material is virtually free of pores, in particular is free of pores to an extent of more than 98% and particularly preferably to an extent of more than 99.9%. This increases the stability of the chip transporting portion and therefore the longevity of the chip transporting portion.

The chip transporting portion can in this case consist uniformly of a material, i.e. both the coupling region and the connection region consist of the same material.

Many different materials each present in powder form are suitable as the material for the tool according to the invention. Examples are steel, aluminum, titanium, tungsten carbide, cobalt and/or cemented carbides.

Alternatively, the chip transporting portion can consist of different materials. By way of example, it is possible that the connection region has been produced from a first material in a sintering process, onto which the coupling region made of a different material has been grown.

The chip transporting portion can also be produced from a gradient material, i.e. a material the properties of which vary along the chip transporting portion. As a result, it is possible to use a more ductile material in a region in which relatively high deformability is required, and to use a material with better hardening properties in a region in which a high hardness is required.

Furthermore, the invention relates to a process for producing a cutting tool, comprising the following steps: a) producing and providing a shank, b) producing and providing a chip transporting portion, consisting of a connection region and a body portion with a cutting edge, and c) connecting the shank and the chip transporting portion.

A hybrid cutting tool can be produced with little expenditure by means of this process, since few process steps are required. Firstly, the shank is produced in a separate process. Then, the chip transporting portion is produced, and is then connected to the shank, such that a complete cutting tool consisting of a shank and a chip transporting portion is obtained. The chip transporting portion is in this case produced at least partially by a process from the group of the rapid prototyping processes, as a result of which complex structures can be manufactured in one process step.

In a particularly preferred process, it is provided that the chip transporting portion is connected to the shank during the production of the chip transporting portion by growing the chip transporting portion onto the shank by means of a process from the group of the rapid prototyping processes. The shank which is present is in this case, for example, introduced into a melting chamber, so that the chip transporting portion can be grown on directly. This means that process steps b) and c) are implemented by a single process step. This accelerates the process for producing the cutting tool and therefore saves costs, since no additional step for connecting the chip transporting portion to the shank is required.

In an alternative process, it is provided that the chip transporting portion and the shank are firstly produced separately, wherein the chip transporting portion is produced by means of a process from the group of the rapid prototyping processes and is then fixedly connected to the shank, in particular the connection region of the chip transporting portion is laser-welded, soldered or screwed to the shank. This makes it possible, for example, to replace a chip transporting portion or to retrofit a shank with a chip transporting portion.

Alternatively, it is possible to produce the chip transporting portion likewise in two separate processes, in which case the connection region is produced, for example, in a sintering process, and the coupling portion for the cutting edge is then grown onto this by means of a process from the group of the rapid prototyping processes. The thus produced chip transporting portion can then be fixedly connected, i.e. for example welded, soldered or screwed, to the shank. The cutting tool is therefore produced in three different substeps, with the cutting tool and also the chip transporting portion being a hybrid composite body. This process therefore makes it possible for the cutting tool or the regions of the cutting tool to be best adapted to the corresponding requirements.

In particular, it is provided that the structure obtained by a process from the group of the rapid prototyping processes is produced in layers, with one layer having a thickness of between 2 μm and 200 μm, in particular of between 25 μm and 50 μm. The production in layers ensures that particularly complex structures can be produced. The rapid prototyping process is therefore particularly well suited for the body portion of the chip transporting portion, since this usually has a complex structure.

### BRIEF DESCRIPTION OF THE ACCOMPANYING FIGURES

Novel features and characteristics of the disclosure are set forth in the appended claims. The disclosure itself, however, as well as a preferred mode of use, further objectives and advantages thereof, will best be understood by reference to the following description of an illustrative embodiment when read in conjunction with the accompanying figures. One or more embodiments are now described, by way of example only, with reference to the accompanying figures, in which, partially in simplified representations:

FIG. 1 shows a cutting tool according to an example embodiment of the present invention,

FIG. 2 shows a chip transporting portion according to an example embodiment of the present invention,

FIG. 3 shows a detailed view of the chip transporting portion of FIG. 2, and

FIGS. 4a-4d show various production steps of a process according to an example embodiment of the present invention.

### DETAILED DESCRIPTION

The foregoing has broadly outlined features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiments disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the disclosure.

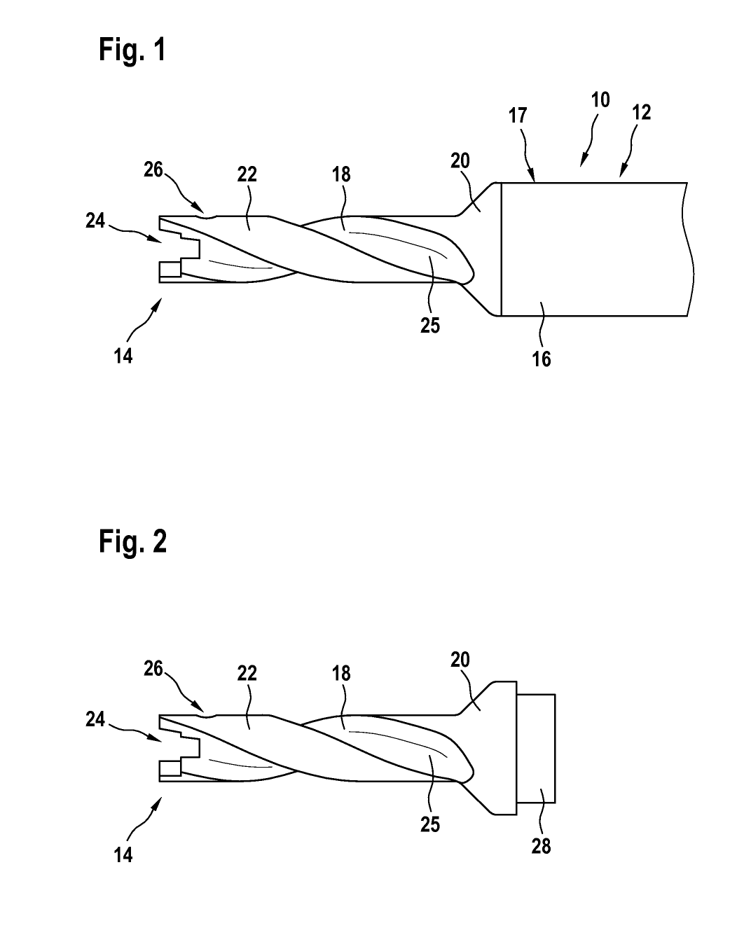

FIG. 1 shows a cutting tool 10 having a first axial end 12 and a second axial end 14. This example embodiment is a drill, however, it is to be appreciated that the invention can also be used for milling cutters, turning and piercing tools or reaming tools.

At its first axial end 12, the cutting tool 10 has a shank 16 with a substantially circular-cylindrical lateral surface 17. Furthermore, the cutting tool 10 has a working portion 18, which here, since this is a drill, is in the form of a chip transporting portion 18, which extends from the shank 16 to the second axial end 14.

The cutting tool 10 can be chucked into a tool holder by means of the shank 16.

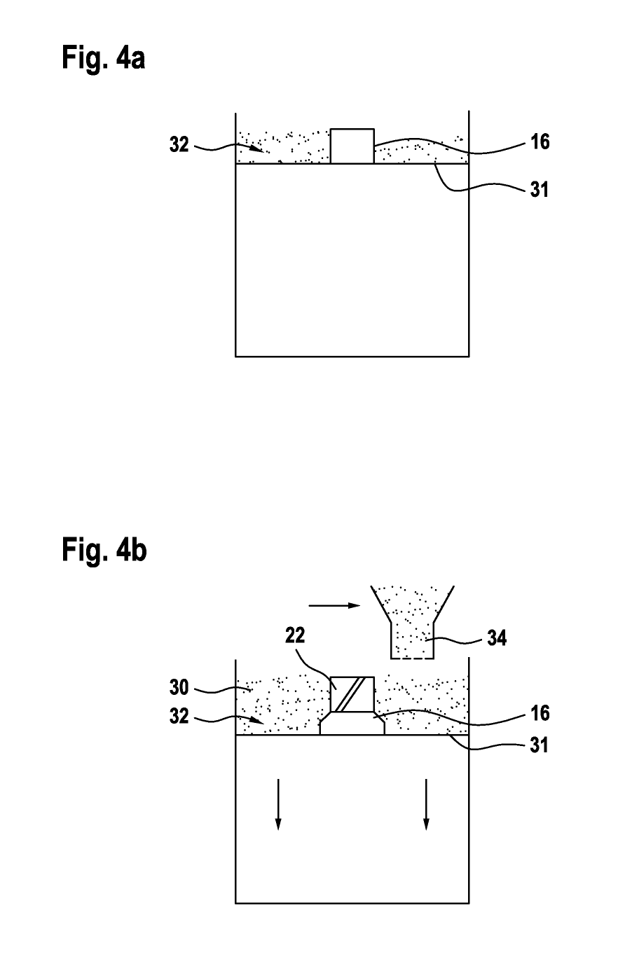

The chip transporting portion 18 has a connection region 20, a body portion 22 and also a coupling region 24. The chip transporting portion 18 is arranged on the shank 16 or connected to the shank 16 by way of the connection region 20. The body portion 22 extends from the connection region 20 to the second axial end 14. The coupling region 24, which serves to receive a cutting insert (not shown here), is formed at the second axial end 14 (see FIG. 3). The cutting insert has geometrically determined cutting edges, which can act on a workpiece to be machined and consist, for example, of cemented carbide.

The body portion 22 has a complex structure, which arises inter alia from two helically running grooves 25. Furthermore, at least one coolant duct 26 runs through the body portion 22 and opens out at the second end of the chip transporting portion 18, such that a cutting insert received in the coupling region 24 can be cooled. The coolant ducts 26 likewise run helically within the body portion 22, such that both the external and the internal structure of the body portion 22 have a correspondingly complex form.

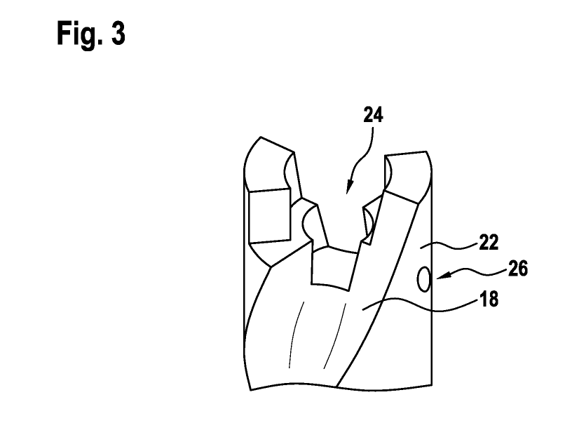

The chip transporting portion 18 with the body portion 22 of complex configuration is shown more clearly in FIG. 2 in a detailed view.

The connection region 20 in particular is readily visible in FIG. 2, and has an insert portion 28 protruding as an attachment from the connection region 20 in an opposite direction to the body portion 22. The chip transporting portion 18 can be pushed into the shank 16 by way of the insert portion 28, the insert portion 28 correspondingly serving to fix the chip transporting portion 18 to the shank 16.

The chip transporting portion 18 can be connected to the shank 16 in many different ways, for example welded, soldered or in a mechanical manner, e.g. by means of a thread. It is also possible to dispense with the insert portion 28 and to butt-weld or to solder the two parts to one another.

Since, as already mentioned above, the structure of the body portion 22 is very complex, in particular on account of the coolant duct 26, a process from the group of the rapid prototyping processes is suitable for producing the body portion 22. Complex structures can be produced in a simple manner by means of such a process, and this is additionally cost-effective.

The group of the rapid prototyping processes includes, inter alia, 3D printing, electron beam melting, laser melting, selective laser melting, selective laser sintering, laser build-up welding and also fused deposition modeling processes. It is common to all the processes that a three-dimensional structure is formed by the layered application, in which case complex structures can be produced in a simple manner without post-machining steps. Post-machining is necessary only if particular requirements in terms of surface quality or tolerances have to be observed.

On account of the process used for producing the chip transporting portion, the cooling ducts (or else the single cooling duct, if just one suffices) can have a complex structure which cannot be achieved by conventional production processes. Thus, the cross section of the cooling ducts can vary along their course. It is possible to incorporate constriction points, with which the coolant flow can be set in the desired manner. It is possible to implement a complex structure acting as a nozzle at the outlet. The course and the arrangement of the coolant duct within the chip transporting portion can be matched to the loads which act on the chip transporting portion during operation, such that the geometrical moment of inertia thereof is optimized in terms of stress.

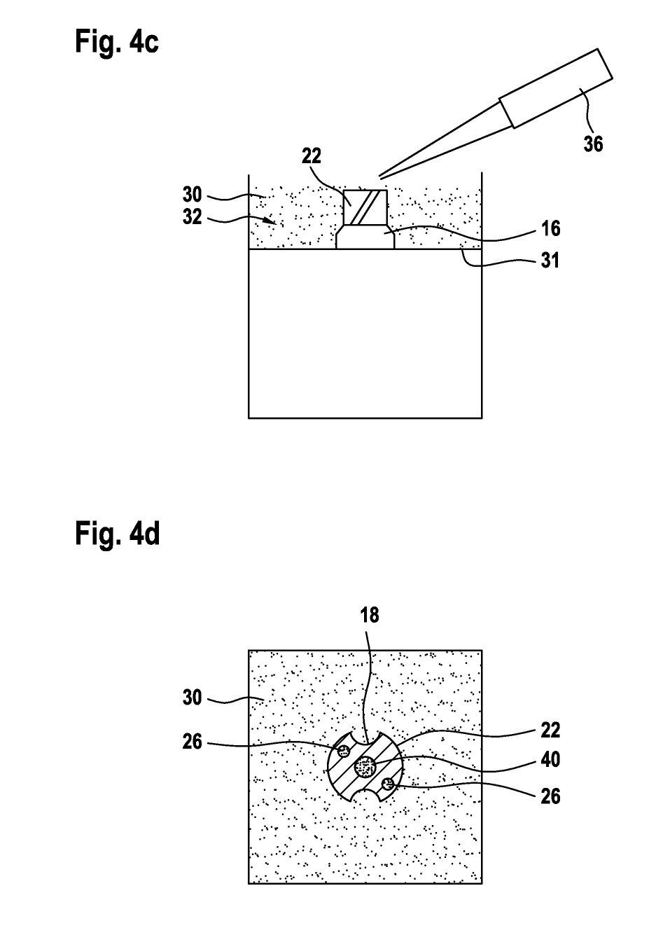

An exemplary production process in accordance with an example embodiment of the present invention will be explained on the basis of FIGS. 4a-4c.

Firstly, a shank 16 which has already been produced is placed into a melting chamber 30 (FIG. 4a), to be more precise on a vertically adjustable support 31. Then, the material from which the chip transporting portion 18 is to be produced is introduced into this melting chamber 30 in powder form, such that the shank 16 is surrounded by the powder 32.

To produce the chip transporting portion 18, new powder 32 is applied in layers and fused. To this end, the support 31 moves downward by the height of a new powder layer, and a new powder layer is applied. For this purpose, use can be made of a powder trolley 34 (or else a slide) (FIG. 4b), which passes over the support and the melting chamber 30.

Once the new powder layer has been applied, the powder is melted by means of a laser 36 (FIG. 4c) at the points at which the tool is to be formed, such that it bonds with the underlying body (the shank 16 in the case of the first layer and with the already formed part of the tool in the case of subsequent layers).

Then, the support moves downward slightly again, and a new powder layer is applied and fusion is effected again, etc. With this process, the chip transporting portion 18 is grown onto the shank 16 layer by layer, where firstly the connection region 20 is grown onto the shank 16 and then the body portion 22 with the complex structure, in particular with the coolant duct 26, is formed. The cutting tool 10 is thereby manufactured proceeding from the shank 16, with the chip transporting portion 18 being grown on in layers toward the second axial end 14. The presently melted material cross section is shown by hatched lines in FIG. 4d.

The layers which are applied can in this case have a layer thickness of 2 to 200 μm, in particular 25 to 50 μm. The layer thickness here depends on the grain size of the material or of the powder used.

Finally, the finished tool 10 is removed from the melting chamber 30.

The process described makes it possible to produce the coolant duct 26 with a variably adapted diameter, for example a diameter in the range of 0.03 mm to 10 mm. The lower limit of the diameter is determined by the grain size of the powder used; once the tool has been finished, it must still be possible for the powder to be removed from the coolant duct. The upper limit of the diameter arises from the fact that an adequate residual cross section of the tool still has to be present for reasons of strength.

The process also makes it possible to form a chamber 40 (see FIG. 4d) in which un-melted powder is enclosed within the material cross section. In this way, it is possible to produce a damping chamber which dampens vibrations.

The process according to the invention makes it possible to produce the chip transporting portion 18 within 1 hour. Moreover, a process of this type makes it possible for a plurality of chip transporting portions 18 to be produced at the same time in one batch.

The chip transporting portions 18 produced by means of these processes have similar or even optimized properties in terms of strength, Youngs modulus, load-bearing capacity and wear resistance compared to the chip transporting portions which are produced conventionally.

Alternative processes for producing the cutting tool 10 provide that the chip transporting portion 18 is likewise a hybrid composite body, since the connection region 20 together with the insert portion 28 has been sintered in a preliminary process, wherein the body portion 22 or else only the coupling region 24 with the complex internal and external structure is grown onto the connection region 20 by means of a process from the group of the rapid prototyping processes. This gives rise to a hybrid chip transporting portion 18, which in turn can be connected to the shank 16 by means of a laser welding process or other processes.

All of these processes for producing a cutting tool 10 according to the invention are distinguished by the fact that at least part of the cutting tool 10 has been produced by means of a process from the group of the rapid prototyping processes, since this process is particularly well suited to producing complex structures.

1. A cutting tool comprising:
a shank; and
a working portion which receives a cutting insert,
wherein the cutting tool is a hybrid composite body.

2. The cutting tool as claimed in claim 1, wherein the cutting tool comprises one of a drill, a milling cutter, a turning tool, a piercing tool or a reaming tool.

3. The cutting tool as claimed in claim 1, wherein the working portion is fixedly connected to the shank.

4. The cutting tool as claimed in claim 3 wherein the working portion is fixedly connected to the shank via laser-weld, solder, or screw.

5. The cutting tool as claimed in claim 1, wherein the working portion is grown directly onto the shank.

6. The cutting tool as claimed in claim 1, wherein the material for the working portion is free of pores to an extent of more than 98%.

7. The cutting tool as claimed in claim 1, wherein the material for the working portion is free of pores to an extent of more than 99.9%.

8. The cutting tool as claimed in claim 1, wherein the working portion has an internal coolant duct.

9. The cutting tool as claimed in claim 8, wherein the coolant duct has a changing cross section.

10. A chip transporting portion for a cutting tool, the chip transporting portion comprising:
a coupling region, which bears a cutting edge; and
a connection region for connecting the chip transporting portion to a shank,
wherein at least the coupling region has been produced by a process from the group of the rapid prototyping processes.

11. The chip transporting portion as claimed in claim 10, wherein the material is free of pores to an extent of more than 98%.

12. The chip transporting portion as claimed in claim 10, wherein the material is free of pores to an extent of more than 99.9%.

13. A process for producing a cutting tool, comprising the following steps:
producing and providing a shank;
producing and providing a working portion having a connection region and a coupling region, which can bear a cutting edge; and
connecting the shank and the working portion.

14. The process as claimed in claim 13, wherein the working portion is connected to the shank during the production of the working portion by applying the working portion to the shank by means of a process from the group of the rapid prototyping processes.

15. The process as claimed in claim 13, wherein the working portion and the shank are firstly produced separately, wherein the working portion is produced by means of a process from the group of the rapid prototyping processes and is then fixedly connected to the shank.

16. The process as claimed in claim 15, wherein the working portion is fixedly connected to the shank by laser-welding, soldering or screwing the connection region of the working portion to the shank.

17. The process as claimed in claim 14, wherein the structure obtained by a process from the group of the rapid prototyping processes is produced in layers, with one layer having a thickness of between 2 μm and 200 μm.

18. The process as claimed in claim 14, wherein the structure obtained by a process from the group of the rapid prototyping processes is produced in layers, with one layer having a thickness of between 25 μm and 50 μm.
